(19) United States
(12) Patent Application Publication
(10) Pub. No.: US 2026/0327015 A1
(43) Pub. Date: Oct. 22, 2026

(54) CONVEYOR BELT SCRAPER BLADE AND A METHOD FOR MANUFACTURING THE SAME

(71) Applicant: Metso Finland Oy, Espoo (FI)

(72) Inventors: Hans Jerker Rolfsson, Trelleborg (SE); Lars Mathias Persson, Trelleborg (SE)

(73) Assignee: Metso Finland Oy, Espoo (FI)

(21) Appl. No.: 19/109,433

(22) PCT Filed: Sep. 4, 2023
(86) PCT No.: PCT/EP2023/074126

§ 371 Date: Mar. 6, 2025

(30) Foreign Application Priority Data
Sep. 9, 2022 (SE) 2251046-5

(51) Int. Cl. B65G 45/16; B33Y 80/00

(52) U.S. Cl. CPC B65G 45/16; B33Y 80/00; B65G 2207/48

(57) ABSTRACT

A conveyor belt scraper blade that includes a supporting structure which includes a base portion and an engagement portion. The engagement portion interconnects with the base portion and extends from the base portion towards a first end of the scraper blade. The engagement portion includes at least one reinforcement portion and a scraper element, wherein the scraper element and the supporting structure are attached to each other along the engagement portion such that the at least one reinforcement portion protrudes into the scraper element thereby reinforcing an attachment between the scraper element and the supporting structure. The supporting structure is made of a first material and the scraper element is made of a second material, wherein the first and second materials are different.

### FIELD OF INVENTION

The present disclosure relates to a conveyor belt scraper blade and a method for manufacturing a conveyor belt scraper blade.

### TECHNICAL BACKGROUND

Scraper blades for conveyor belts are used for cleaning the conveyor belt from material that gets stuck and therefore remains on the conveyor belt after the conveyed material leaves the same. There are many parameters that are important for the functionality of the scraper blade. The scraper blade needs to have a stable construction to keep its shape during the stress exerted thereon during use. It also needs to have good wear characteristics to reduce downtime due to scraper replacement. If the scraper blade needs to be replaced too often it is a problem both economically and for the environment, due to a waste of resources. When a scraper blade for a conveyor belt is in operation, it will gradually wear as a result from the frictional forces exerted thereon from the movable conveyor belt. At the end of the service life of the scraper blade, a large portion of the scraper blade will have been removed by wear, whereby it will be time to replace the scraper blades to maintain required conveyor belt cleaning. After replacement, what remains left of the old scraper blade must be disposed of. A problem with the scraper blades of the art is that, once at the end of their service life, their remaining parts makes up considerable amount of waste. There is thus a need in the art for an improved scraper blade which reduces the amount of waste material during replacement.

### SUMMARY

It is an object to mitigate, alleviate or eliminate one or more of the above-identified deficiencies in the art and disadvantages singly or in any combination. These and other objects are at least partly met by the invention as defined in the independent claims. Preferred embodiments are set out in the dependent claims.

According to a first aspect there is provided a conveyor belt scraper blade having an extension along a scraper axis and configured to scrape off material from a conveyor belt surface along a scraping region extending in parallel with the scraper axis, the conveyor belt scraper blade presenting a scraper tip at a first end and a mounting base at a second, opposite, end and being tapered towards the scraper tip at least at the first end,
the conveyor belt scraper blade comprising:
a supporting structure which comprises a base portion and an engagement portion, wherein the base portion includes the mounting base, and wherein the engagement portion interconnects with the base portion and extends from the base portion towards the first end, wherein the engagement portion comprises at least one reinforcement portion, and
a scraper element,
wherein the scraper element and the supporting structure are attached to each other along the engagement portion such that the at least one reinforcement portion protrudes into the scraper element thereby reinforcing an attachment between the scraper element and the supporting structure,
wherein the conveyor belt scraper blade is structured and arranged to wear off during use and the scraper element is arranged with respect to the supporting structure such that the scraper element, at the end of a service life of the conveyor belt scraper blade, is fully or partially worn off,
wherein the supporting structure is made of a first material and the scraper element is made of a second material, and wherein the first and second materials are different.

The conveyor belt scraper blade may be advantageous since its supporting structure allows selecting which parts of the conveyor belt scraper blade that should house the scraper element. By selectively shaping and disposing the scraper element at positions that will be worn off until the end of the service life of the conveyor belt scraper blade, the total required volume of material needed to manufacture a conveyor belt scraper blade will decrease and a bigger portion of the conveyor belt scraper blade can be used before remaining parts thereof is disposed of as waste. The use of two different materials also allows selecting the material characteristics independently from each other. This may allow a supporting structure having its preferred characteristics to contribute with one function of the conveyor belt scraper blade, and the scraper element having other characteristics to contribute with another function.

One purpose of the supporting structure is to aid in defining the shape of the conveyor belt scraper blade. Another purpose of the supporting structure is to provide structural support and integrity to the conveyor belt scraper blade. An advantage of the conveyor belt scraper blade is that its two different materials allow minimizing the amount of material for holding the structural shape of the conveyor belt scraper blade. This may allow minimizing both the amount of material used for the supporting structure and the amount of material used for the scraper element. As a result of this, the conveyor belt scraper blade may have a smaller environmental footprint and be more economically beneficial.

During use, the conveyor belt scraper blade will be subject to wear at the contact point between the scraper blade and the conveyor belt. The wear will occur at the position of the scraper which contacts the conveyor belt. A newly replaced conveyor belt scraper blade may therefore first be subject to wear of the scraper element alone. However, after some time, the wear may have increased to a level where also the engagement portion of the supporting structure will meet the conveyor belt. Thus, the scraper element can be subject to wear both alone and together with the supporting structure. At the end of the service life of the conveyor belt scraper blade, the scraper element is fully or partially worn off. Thus, when replacing the conveyor belt scraper blade, the waste material will predominately, or only, comprise the remaining parts of the supporting structure. Since the remaining parts of the supporting structure is not intended to perform any scraping, the remaining parts of the supporting structure may be structured and arranged to provide structural integrity only, which allows for a design with a reduced amount of material compared to the scrapers of the art.

The conveyor belt scraper blade is intended to be positioned in relation to a conveyor belt such that its upper end will be in contact with the conveyor belt along a scraping region. The scraping region extends in parallel with the extension of the conveyor belt scraper blade. The scraping region also extends generally in parallel with a rotational axis of the conveyor belt. This implies that the scraping region extends generally transverse to a traveling direction of the conveyor belt. Typically, a plurality of conveyor belt scraper blades is arranged mutually adjacent to each other to form a common conveyor belt scraper structure long enough to scrape parts of, or the entire width of the conveyor belt.

As readily appreciated by the person skilled in the art, the active parts of the conveyor belt scraper blade which are in abutment with the conveyor belt will gradually move as the conveyor belt scraper blade wears down during use. However, as used herein, the terms “scraper tip”, “first end”, etc. will always refer to an unworn, or unused, conveyor belt scraper blade.

The term “engagement portion” should be construed herein as a portion of the supporting structure which engages with the scraper element. This implies that the engagement portion has an engagement surface onto which the scraper element is attached. The engagement surface may have at least one engagement surface portion which extends from the base portion towards the first end. The engagement surface may have at least one engagement surface portion which extends along an intersection between the base portion and the engagement portion. Each reinforcement portion of the one or more reinforcement portions may protrude outwardly from any one of the engagement surface portions of the engagement portion. As readily appreciated by the person skilled in the art, the above implies that the scraper element is located closer to the first end than the base portion. The engagement portion may extend from the base portion to the first end thus connecting the base portion with the first end. For such an example embodiment, the supporting structure will comprise the scraper tip. It is however conceivable that the engagement portion only extend from the base portion towards the first end but not all the way to the first end. For such an example embodiment, the scraper element will comprise the scraper tip.

According to some embodiments, the engagement portion protrudes into the scraper element such that the scraper element partially encloses the engagement portion from the base portion towards the first end in directions being transverse to the scraper axis. This implies that the scraper element is attached to the supporting structure on more than one side thereof. For other embodiments, the scraper element may be attached to the supporting structure on only one side thereof. The fact that the engagement portion interconnects with the base portion and extends from the base portion towards the first end implies that the engagement portion may have an engagement surface which has one engagement surface portion facing away from the conveyor belt, and one engagement surface portion facing the conveyor belt, when in use. For embodiments where the engagement portion protrudes into the scraper element such that the scraper element partially encloses the engagement portion from the base portion towards the first end in directions being transverse to the scraper axis, the engagement portion may be attached to the scraper element along both these two engagement surface portions.

The directions which are transverse to the scraper axis include a first direction extending from the first end to the second end of the conveyor belt scraper blade and a second direction which is orthogonal to the first direction and to the scraper axis. The second direction thus generally extend along the moving direction of the conveyor belt when the conveyor belt scraper blade is in use.

An advantage with providing an engagement portion which protrudes into the scraper element such that the scraper element partially encloses the engagement portion from the base portion towards the first end in directions being transverse to the scraper axis is that the scraper blade may be easier to manufacture. Another advantage is that the scraper blade may have higher structural integrity. Yet another advantage is that the scraper blade may be easier to recycle.

It is stressed that the above does not imply that the scraper element encloses the engagement portion in all three dimensions. The scraper element may be structured to not enclose the engagement portion along the scraper axis.

According to some embodiments, the supporting structure has a constant cross-sectional profile along the scraper axis.

According to some embodiments, the supporting structure is manufactured, at least in part, by an extrusion process, an injection moulding process, or a 3D printing process.

The extrusion process is a reliable process for providing the product with the constant cross-sectional profile of the supporting structure. It allows manufacturing elements with relatively complex shapes, also having hollow spaces. Also, it allows manufacturing elements with a relatively long length. This may allow manufacturing long conveyor belt scraper blades to allow covering the entire scraping width with a single scraper blade. The injection moulding process is also regarded as a reliable process for manufacturing the supporting structure. It is a versatile technique and allows manufacturing very complex shapes. Specifically, it may allow manufacturing supporting structures having a varying cross-sectional profile along the scraper axis. The 3D-printing process is also regarded as a reliable process for manufacturing the supporting structure. Although manufacturing time may be less fast, it allows manufacturing very complex shapes. Moreover, modifications in the design are more easily implemented, as dedicated elements such the tailored moulds used in the extrusion and injection moulding processes do not have to be designed and fabricated.

According to some embodiments, the second material comprises a polymer.

According to some embodiments, the second material comprises polyurethane or a thermoplastic elastomer.

Polyurethane may provide low friction, high wear resistance, and high strength. Another advantage is that a polyurethane-based scraper element may be formed by moulding. The second material may be a polyurethane composite material. Thermoplastic elastomers (TPE) show advantages typical of both rubbery materials and plastic materials. The benefit of using thermoplastic elastomers may be the ability to stretch to moderate elongations and return to its near original shape creating a longer life and better physical range than many other materials. Another advantage of thermoplastic elastomers may be that, while most elastomers are thermosets, thermoplastic elastomers are in contrast relatively easy to use in manufacturing, for example, by injection moulding and extrusion processes. The thermoplastic elastomer may be thermoplastic polyurethane (TPU). Thermoplastic elastomers include at least: styrenic block copolymers, TPS (TPE-s), thermoplastic polyolefinelastomers, TPO (TPE-o), thermoplastic Vulcanizates, TPV (TPE-v or TPV), thermoplastic polyurethanes, TPU (TPU), thermoplastic copolyester, and TPC (TPE-E), and thermoplastic polyamides, TPA (TPE-A). Examples of TPE materials that come from block copolymers group are amongst others CAWITON, THERMOLAST K, THERMOLAST M, Arnitel, Hytrel, Dryflex, Mediprene, Kraton, Pibiflex, Sofprene, and Laprene. Out of these styrenic block copolymers (TPE-s) are CAWITON, THERMOLAST K, THERMOLAST M, Sofprene, Dryflex and Laprene. Laripur, Desmopan or Elastollan are examples of thermoplastic polyurethanes (TPU). Sarlink, Santoprene, Termoton, Solprene, THERMOLAST V, Vegaprene, or Forprene are examples of TPV materials. Examples of thermoplastic olefin elastomers (TPO) compound are For-Tec E or Engage.

The second material could also comprise other kind of materials suitable for scraping the conveyor belt, for example rubber.

It is also conceivable to blend further compounds into the material. As an example, carbide may be suitable for some embodiments of the conveyor belt scraper blade since it is highly wear resistant. In other words, the scraper element may be made from a material which includes e.g. a carbide powder. The carbide powder may be mixed with a polymeric material such as polyurethane. It is also conceivable to provide a scraper element which includes other ceramic powders, or a graphene powder.

According to some embodiments, the first material is biodegradable and/or biobased. Providing a first material which is biodegradeable and/or biobased allows to further reduce the impact on the environment. When the remaining part of a worn-out scraper is replaced, it may be disposed of in a sustainable way. It may for example be shredded into smaller elements and composted. Thus, the provision of these materials may completely remove, or at least reduce, the increase of landfill.

According to some embodiments, the first material has a higher hardness than the second material. The hardness of the material may be measured with a Shore durometer. The second material may have a hardness of 50-95° Shore A and in general more preferably 70° Shore A. When the first material is a harder material than the second material the supporting structure can provide the stability needed for the conveyor belt scraper blade to keep its shape during use.

The increased stability of the supporting structure may be advantageous because it allows the use of a softer material for the scraper element, even a material with a hardness that would not keep its shape by itself during usage may be used. The softer material is often more abrasion resistant which increases the lifetime of the conveyor belt scraper blade. An advantage with an increased lifetime is that the need for maintenance of the conveyor belt decreases as the conveyor belt scraper blade does not need to be replaced as often.

According to some embodiments, the first material comprises a polymer.

According to some embodiments, the first material comprises one or more from the list of: a thermoplastic elastomer, polyvinyl chloride, acrylonitrile styrene acrylate and polyethylene.

The first material may be a thermoplastic polymer. One suitable thermoplastic polymer may be acrylonitrile styrene acrylate (ASA), also called acrylic styrene acrylonitrile, which is an amorphous thermoplastic developed as an alternative to acrylonitrile butadiene styrene (ABS). It is an acrylate rubber-modified styrene acrylonitrile copolymer. It has high UV resistance and mechanical properties making it a suitable material for use in an extrusion process.

The first material may comprise a biodegradable thermoplastic elastomer. The first material may be a composition of two or more compounds. The two or more compounds may be selected from the list of thermoplastic elastomers, polyvinyl chloride, or polyethylene, but may alternatively be selected from other compounds.

The first and second materials may each be a respective composition which comprises the same compound. For example, the first and second material may each comprise a specific thermoplastic elastomer or may each comprise polyurethane. The difference between the first and second materials will in this case depend on the composition, where other compounds part of the composition may be different.

Alternatively, or additionally, the first and second materials may comprise different species within the same group of materials. For example, the first material may comprise a first thermoplastic elastomer and the second material may comprise a second, different, thermoplastic elastomer.

According to some embodiments, each of the one or more reinforcement portions has a proximal end which connects to the engagement portion, and a distal end arranged opposite to the proximal end, wherein the distal end comprises an anchoring portion which has a thickness being larger than a thickness of the reinforcement portion, the thicknesses being defined in a plane being transverse to the scraper axis. The anchoring portions may be advantageous as they aid in securing the scraper element to the supporting structure by means of a locking engagement. This further aids in holding the scraper blade together, thus increasing structural integrity and durability of the scraper blade.

According to some embodiments, the anchoring portion comprises two sub portions which protrude out from the distal end in different directions. An angle between the two sub portions may be within the range 20 to 180 degrees, preferable 70 to 110 degrees. The two sub portions may extend outwardly away from the engagement portion. Alternatively, the two sub portions may extend inwardly towards the engagement portion. It is also conceivable to only have one sub portion. In such a case the sub portion may protrude out from the distal end in a direction being different from the direction of the reinforcement portion.

The anchoring portion may be embodied in many alternative ways, for example having a circular cross section, or a square cross section. As long as the thickness of the reinforcement portion is larger than the thickness of the anchoring portion, a locking engagement will be achieved.

According to some embodiments, the supporting structure comprises one or more hollow portions each defining a respective interior volume. The one or more hollow portions may be advantageous because they further reduce the overall volume of the conveyor belt scraper blade, and allow for reducing the volume of the waste when a worn-out conveyor belt scraper blade is disposed of at the end of its service life. Another advantage of the hollow portions may be that they make the conveyor belt scraper blade easier to handle due to its lighter weight.

Each of the one or more hollow portions may be a through-opening extending through the supporting structure along the scraper axis.

According to some embodiments, the one or more hollow portions are located within the base portion.

According to some embodiments, the one or more hollow portion comprises a first hollow portion which is located within the mounting base. The first hollow portion may be used for mounting the conveyor belt scraper blade. It may also be used for attaching means for mounting the conveyor belt scraper blade.

According to some embodiments, the one or more hollow portions comprises a second hollow portion which is located between the mounting base and the scraper portion. The second hollow portion may contribute to a more efficient use of material.

According to some embodiments, the supporting structure (110) comprises one or more through-holes which extend through the engagement portion. Each of the one or more through-holes may extend in a direction being transverse to the scraper axis. The one or more through-holes may be advantageous because they may allow the second material which constitutes the scraper element to extend therethrough thus further strengthening the structural integrity of the scraper blade. The one or more through-holes may extend through any part of the engagement portion. For example, the one or more through-holes may extend through one or more of the reinforcement portions. The one or more through-holes may extend through the engagement portion along a direction being transverse to the scraper axis.

According to a second aspect there is provided a conveyor belt scraper assembly for scraping off material from a conveyor belt surface. The conveyor belt scraper assembly comprising:
a plurality of conveyor belt scraper blades according to the first aspect, and
a support shaft structured and arranged to support the plurality of conveyor belt scraper blades, and
tensioning means configured to exert a torque or a force onto the support shaft for pressing the plurality of conveyor belt scraper blades towards the conveyor belt surface.

According to a third aspect there is provided a method of manufacturing a conveyor belt scraper blade which presents a scraper tip at a first end and a mounting base at a second, opposite, end and which is tapered towards the scraper tip at least at the first end, the method comprising the steps of:
a) manufacturing a supporting structure made of a first material, wherein the supporting structure comprises a base portion and an engagement portion, wherein the base portion includes the mounting base, and wherein the engagement portion interconnects with the base portion and extends from the base portion towards the first end, wherein the engagement portion comprises at least one reinforcement portion, and
b) arranging a scraper element made of a second material to the supporting structure such that the scraper element and the supporting structure becomes attached to each other along the engagement portion and such that the at least one reinforcement portion protrudes into the scraper element thereby reinforcing an attachment between the scraper element and the supporting structure.

According to some embodiments, the step of manufacturing the supporting structure is achieved, at least in part, by an extrusion process, an injection moulding process, or a 3D printing process. If an embodiment of the supporting structure which has one or more through-holes is to be manufactured at least in part by an extrusion process, a supporting structure without through-holes may first be manufactured by the extrusion process, and the one or more through-holes provided therein in a second step, e.g. by drilling.

According to some embodiments, the step of arranging the scraper element to the supporting structure comprises:
arranging the supporting structure into a mould,
supplying the second material in liquid form into the mould such that the second material meets the supporting structure along the engagement portion,
whereby the second material binds with the first material of the supporting structure to form a coherent structure during cooling.

According to some embodiments of the method, the first and second materials are different.

The supporting structure may be manufactured as a whole in a single manufacturing step but may alternatively be manufactured in parts which are later attached to each other in a second step to form the supporting structure. As an example, the supporting structure may be manufactured by an extrusion process by manufacturing two or more separate sections, which are subsequently attached to each other. This modular manufacturing process may be beneficial for longer conveyor belt scraper blades, where manufacturing using e.g. an extrusion process may become challenging. The modular manufacturing process provides an additional advantage in that it allows providing reinforcement structures within the supporting structure which are not extending along the scraper direction prior to mounting the modules together.

Effects and features of the second and third aspects are largely analogous to those described above in connection with the first aspect. Embodiments mentioned in relation to the first aspect are largely compatible with the second aspect and third aspects. It is further noted that the inventive concepts relate to all possible combinations of features unless explicitly stated otherwise.

A further scope of applicability of the present disclosure will become apparent from the detailed description given below. However, it should be understood that the detailed description and specific examples, while indicating preferred embodiments of the disclosure, are given by way of illustration only, since various changes and modifications within the scope of the disclosure will become apparent to those skilled in the art from this detailed description.

Hence, it is to be understood that this disclosure is not limited to the particular component parts of the device described or steps of the methods described as such device and method may vary. It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The disclosure will by way of example be described in more detail with reference to the appended drawings, which shows presently preferred embodiments of the disclosure.

FIG. 1 is a perspective view of a conveyor belt scraper assembly according to an example embodiment of the disclosure.

FIG. 2A is a perspective view of a conveyor belt scraper blade according to an example embodiment of the disclosure.

FIG. 2B is a perspective view of a supporting structure of the conveyor belt scraper blade of FIG. 2A.

FIG. 3A is a cross-sectional view of the supporting structure of the conveyor belt scraper blade of FIG. 2A and B.

FIG. 3B is a cross-sectional view of the scraper element of the conveyor belt scraper blade of FIG. 3A.

FIG. 3C is a cross-sectional view of a reinforcement portion of the conveyor belt scraper blade of FIG. 3A.

FIG. 4A is a cross-sectional view of a supporting structure of a conveyor belt scraper blade according to an alternative example embodiment.

FIG. 4B is a cross-sectional view of a scraper element of the conveyor belt scraper blade of FIG. 4A.

FIG. 4C is a perspective view of the supporting structure of FIG. 4A.

FIG. 5 is a flow chart illustrating the different steps in a method for manufacturing a conveyor belt scraper blade according to the disclosure.

FIG. 6A is a schematic side view of the supporting structure of FIG. 4A-C being inserted into a mould.

FIG. 6B is a schematic side view of the supporting structure and mould of FIG. 6A after the mould has been filled with second material soon to become the scraper element of FIG. 4B.

FIG. 6C is a schematic side view of the supporting structure and the scraper element after the mould has been removed.

### DETAILED DESCRIPTION

The present disclosure will now be described more fully hereinafter with reference to the accompanying drawings, in which currently preferred embodiments of the disclosure are shown. This disclosure may, however, be embodied in many different forms and should not be construed as limited to the embodiments set forth herein; rather, these embodiments are provided for thoroughness and completeness, and fully convey the scope of the disclosure to the skilled person.

Conveyor belts are used to transport large volumes of material from one location to another location. In certain applications, for example within the mining industry, conveyor belts are used to transport material such as sand, ore, gravel, coal, minerals, and the like. For such applications, material tend to adhere to the conveyor belt surface which therefore needs to be cleaned.

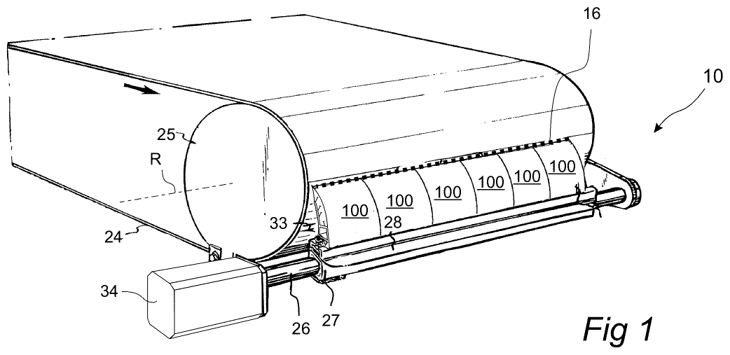

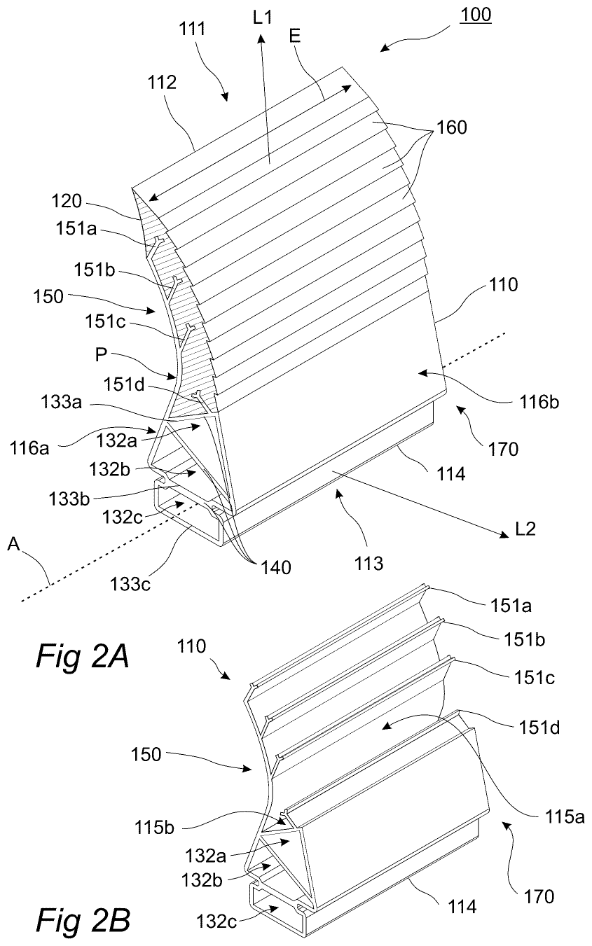

One known solution to keep the conveyor belt clean is to mechanically remove material that gets stuck on the belt surface. An example of a cleaning system of this kind is illustrated in FIG. 1 in the form of a conveyor belt scraper assembly 10. The conveyor belt scraper assembly 10 comprises a plurality of conveyor belt scraper blades 100 arranged mutually adjacent to each other to form a common conveyor belt scraper structure long enough to scrape the entire, or at least a major part of, the width of the conveyor belt surface 24. The conveyor belt scraper assembly 10 comprises a support shaft 26 which is structured and arranged to support a plurality of conveyor belt scraper blades 100. The conveyor belt scraper blades 100 will be more thoroughly described in connection to FIG. 2A and B. The support shaft 26 is configured to press the plurality of conveyor belt scraper blades 100 towards the conveyor belt surface 24 through suitable tensioning means 34. The tensioning means 34 is configured to exert a torque or a force onto the support shaft 26 such that the support shaft 26 presses the conveyor belt scraper blades 100 towards the conveyor belt surface 24. As appreciated by the person skilled in the art, there are many such suitable tensioning means known in the art, based on for example biasing by springs or weights. For the purpose of the present disclosure, the tensioning means 34 has therefore only been conceptually illustrated in FIG. 1. When the conveyor belt surface 24 moves in relation to the conveyor belt scraper blades 100, the scraper blades 100 will scrape the stuck material off from the conveyor belt surface 24. The conveyor belt scraper blades 100 are attached to a mounting element 28 that is rigidly fastened to a square tube 27 which in turn is attached to the supporting shaft 26. The mounting element 28 and the conveyor belt scraper blades 100 mounted thereon can thus easily and quickly be mounted and dismounted as a single unit. The conveyor belt scraper blades 100 are attached to the supporting shaft 26 via a respective mounting base 114 (See e.g. FIG. 2A). The mounting base 114 may be shaped in such way that it forms a locking engagement with the supporting shaft 26. The conveyor belt scraper blade 100 is intended to be positioned in relation to a conveyor belt surface 26 such that its upper end 111 will be in contact with the conveyor belt surface 26 along a scraping region 16 (see dotted line in FIG. 1). The scraping region 16 extends in parallel with the extension of the conveyor belt scraper blade 100. The scraping region 16 also extends generally in parallel with a rotational axis R of the conveyor belt pullies 25.

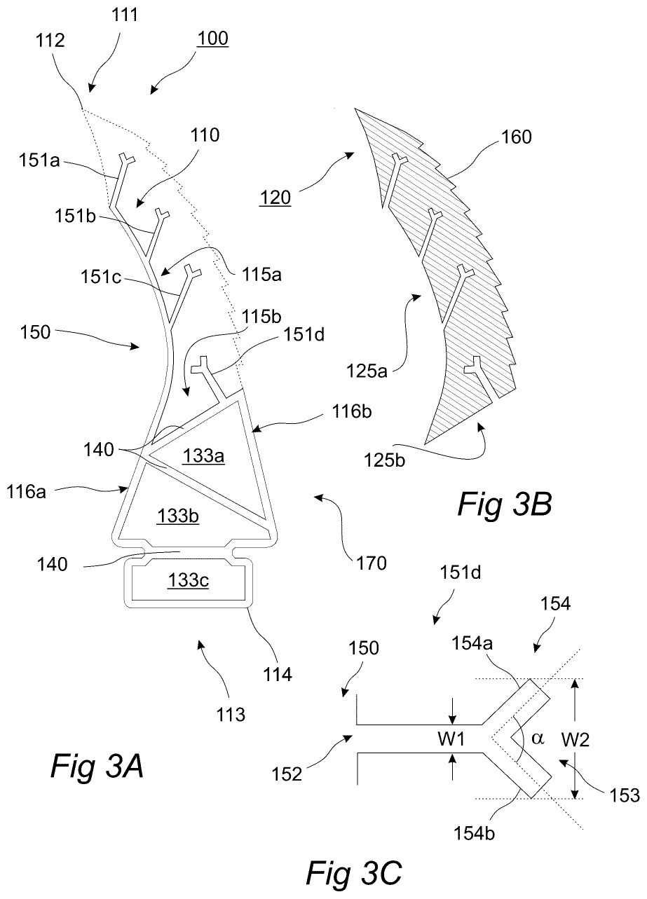

FIGS. 2A-2B and 3A-3C illustrate a conveyor belt scraper blade 100 according to an example embodiment. The conveyer belt scrape blade 100 extends along a scraper axis A and presents a scraper tip 112 at a first end 111 and mounting base 114 at a second 113, opposite, end. The conveyor belt scraper blade 100 is tapered towards the scraper tip 112 at least at the first end 112. The conveyor belt scraper blade 100 comprises a supporting structure 110 and a scraper element 120 which are attached to each other. For the example embodiment, the supporting structure 110 presents the scraper tip 112, but for alternative embodiments (not shown), the supporting structure comprises the scraper tip.

The supporting structure 110 comprises a base portion 170 which includes the mounting base 114. The supporting structure 110 further comprises an engagement portion 150 which interconnects with the base portion 170 and extends from the base portion towards the first end 111. As can be seen in FIG. 2A, the engagement portion 150 extends from the base portion 170 but only partially to the first end 111. Instead, the scraper element 120 presents the scraper tip 112 and thereby defines the first end 111 of the scraper blade 100. The engagement portion 150 comprises at least one reinforcement portion 151a-d (in the example embodiment: four reinforcement portions 151a-d). For the example embodiment, the four reinforcement portions 151a-d are generally similar. As an example, engagement portion 151d is illustrated in more detail in FIG. 3C and will be further described below.

As can be seen in FIG. 2A, the scraper element 120 and the supporting structure 110 are attached to each other along the engagement portion 150 such that the at least one reinforcement portion 151a-d protrudes into the scraper element 120 thereby reinforcing an attachment between the scraper element 120 and the supporting structure 110. As best illustrated in FIG. 3C, each of the one or more reinforcement portions 151a-d has a proximal end 152 which connects to the engagement portion 150, and a distal end 153 arranged opposite to the proximal end 152, wherein the distal end 153 comprises an anchoring portion 154 which has a thickness W2 being larger than a thickness W1 of the reinforcement portion 151a-d, the thicknesses W1, W2 being defined in a plane being transverse to the scraper axis A. The purpose of the anchoring portion 154 is to aid in securing the scraper element 120 to the supporting structure 110 by means of a locking engagement. For the example embodiment, the anchoring portion 154 comprises two sub portions 154a, 154b which protrude out at the distal end 153 in different directions. These directions are illustrated in FIG. 3C with dotted lines. The angle between the two sub portions 154a, 154b may be within the range 30 to 120 degrees, preferably within 60 to 100 degrees. In the example embodiment, the angle is 90 degrees. As illustrated in FIG. 3C, the two sub portions 154a, 154b extend outwardly away from the engagement portion 150. For other example embodiment (not shown), the two sub portions may extend inwardly towards the engagement portion. For yet other embodiments (not shown), there is only one sub portion which protrudes out from the distal end in a direction being different from the direction of the reinforcement portion. As readily appreciated by the person skilled in the art, the anchoring portion 154 may be embodied in many alternative ways, for example having a circular cross section, or a square cross section. As long as the thickness W2 is larger than the thickness W1, a locking engagement will be achieved.

As best illustrated in FIG. 2B, the supporting structure of the conveyor belt scraper blade 100 has a constant cross-sectional profile along the scraper axis A. This opens for certain advantages for manufacturing the conveyor belt scraper blade 100, as will be detailed later.

The engagement portion 150 is defined herein as the portion of the supporting structure 110 that is in engagement with the scraper element 120. As can be seen in FIGS. 2A and 2B, the engagement portion 150 extends from the base portion 170 towards the first end 111. The engagement portion 150 further extends outwardly at the bottom of the engagement portion 150 so as to support the scraper element 120 from beneath. This implies that the engagement portion 150 has an engagement surface 115a, 115b which has two engagement surface portions, namely engagement surface portion 115a which meets engagement surface portion 125a of the scraper element 120, and engagement surface portion 115b which meets engagement surface portion 125b of the scraper element 120. The engagement surface portion 115a extends from the base portion 170 towards the first end 111, and engagement surface portion 115b extends along the intersection between the base portion 170 and the engagement portion 150. The engagement surfaces 115a-b, 125a-b are most clearly illustrated in FIG. 3A and FIG. 3B, respectively.

The supporting structure 110 comprises one or more hollow portions 133a-c each defining a respective interior volume 132a-c (see FIGS. 2A and B). The one or more hollow portions 133a-c of the example embodiment are located within the base portion 170 and includes three hollow portions 133a-c. Alternative embodiments may have other number of hollow portions 133a-c, or no hollow portions 133a-c. The one or more hollow portions 133a-c may be through-openings extending through the supporting structure 110 along the scraper axis A. The one or more hollow portions 133a-c are separated from each other by separating structures 140 which interconnects opposing walls 116a, 116b of the base portion 170. The separating structures 140 may be walls that fully separate the adjacent hollow portions 133a-c from each other. The separating structures 140 are connected at each end to one of the opposing walls 116a, 116b. The opposing walls 116a, 116b are for the present example embodiment defined as the walls that extend from the mounting base 114 in the direction towards the first end 111. In other embodiments, the separating structure 140 may extend between other walls of the supporting structure 110. With the one or more hollow portions 133a-c, many different designs of the conveyor belt scraper blade 100 are possible. It is also possible to adapt the conveyor belt scraper blade 100 to different conveyor belt scraper assemblies 10. The hollow portions 133a-c decreases the weight of the conveyor belt scraper blade 100 and thus makes it easier to handle. A further advantage with the separating structure 140 may be that it provides a distinct separation of the portions. This makes it easy to manufacture the conveyor belt scraper blade with the desired shape and characteristics. The hollow portions 133a-c in FIG. 2A consists of a first hollow portion 133c which is located within the mounting base 114 and two hollow portions 133a, 133b located in the upper parts of the base portion 170 between the mounting base 114 and the scraper element 120. To reduce the amount of waste material produced when replacing worn-out conveyor belt scraper blades, preferably the scraper element 120 only encompasses the part of the scraper blade that will be worn down during use. Hence, as readily appreciated by the person skilled in the art, the inclination of each separating structure 140, the number of them, as well as the number of hollow portions 133a-c may be design parameters.

The scraper element 120 may have a plurality of fins 160 at one of the walls that extends from the scraper tip 112 to the mounting base 114 so as to provide a stepped, or serrated, surface. Each of the fins 160 extends along the scraper axis and covers the full extension E of the conveyor belt scraper blade 100.

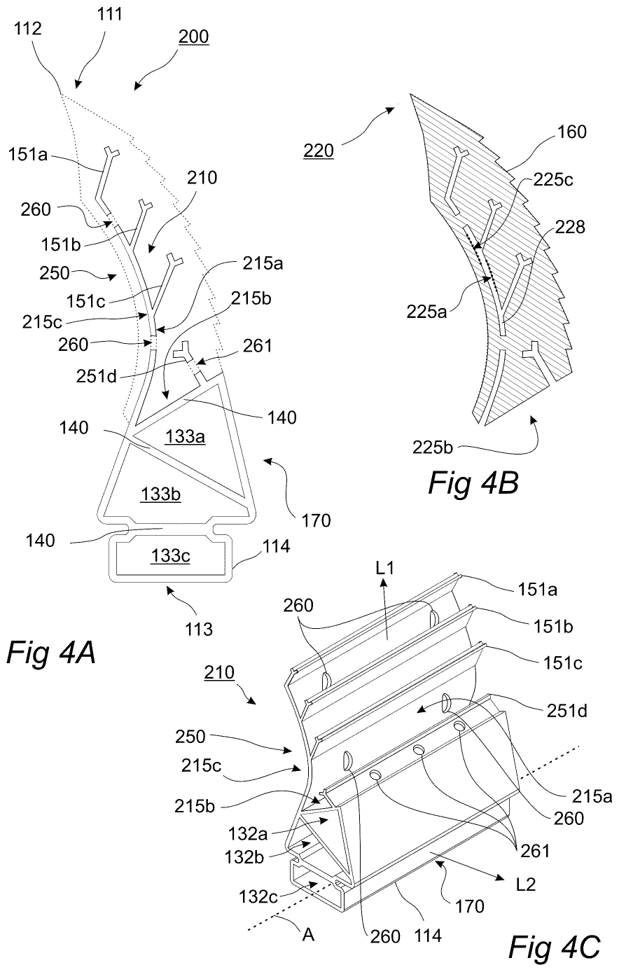

Turning to FIG. 4A-C, an alternative embodiment of the conveyor belt scraper blade is disclosed, namely the conveyor belt scraper blade 200. As readily appreciated by the person skilled in the art when viewing the figures, this alternative embodiment share several features with the conveyor belt scraper blade 100 described hereinabove. To increase clarity, the features which is in common with the first embodiment will be assigned the same reference number, whereas features which are unique to the second example embodiment will have a higher-order reference number.

The conveyor belt scraper blade 200 differs from the conveyor belt scraper blade 100 in that the engagement portion 250 protrudes into the scraper element 220 such that the scraper element 220 partially encloses the engagement portion 250 from the base portion 170 towards the first end 111 in directions L1, L2 being transverse to the scraper axis A. As can be seen in FIG. 4A and B, the supporting structure 210 meets the scraper element 220 on more than one side thereof. The engagement portion 250 has an engagement surface 215a-c which may be divided into three distinct engagement surface portions. Similar to the first example embodiment, engagement surface portion 215b extends along an intersection between the base portion 170 and the engagement portion 250. The other two engagement surface portions 215a, 215c are defined on the part of the engagement portion 250 which extends towards the first end 111 and include engagement surface portion 215a which faces away from the conveyor belt, and engagement surface portion 115c which faces towards the conveyor belt, when in use (the conveyor belt would be located to the left of the scraper blade 200 in FIG. 4A). In other words, the engagement portion 250 is attached to the scraper element 220 on two opposite sides of the engagement portion 250. An advantage with providing an engagement portion 250 which protrudes into the scraper element 220 such that the scraper element 220 partially encloses the engagement portion 250 from the base portion 170 towards the first end 111 in directions being transverse to the scraper axis A is that the scraper blade 200 may be easier to manufacture. Another advantage is that the scraper blade 200 may have higher structural integrity.

As previously mentioned, the engagement portion 250 is defined herein as the portion of the supporting structure 210 that is in engagement with the scraper element 220. As can be seen in FIGS. 4B and 4C, the engagement portion 250 extends from the base portion towards the first end 111. The engagement portion 250 further extends outwardly at the bottom of the engagement portion 250 so as to meet the scraper element 220 from beneath. In this aspect, the supporting structure 210 is similar to the supporting structure 110. However, the engagement surfaces differ between embodiments. The engagement portion 250 has both engagement surface portion 215a and engagement surface portion 215c which are arranged on opposite sides of the engagement portion 250. The scraper element 220 therefore has complementary engagement surface portions 225a, 225c being defined as inner surfaces of a cavity 228, as illustrated in FIG. 4B. Finally, the scraper element 220 has an engagement surface portion 225b which is attached to engagement surface portion 215b of the supporting structure 210.

As can also be seen in FIGS. 4B and C, the supporting structure 210 comprises one or more through-holes 260, 261 which extend through the engagement portion 250. The through-holes 260, 261 extend through the engagement portion 250 along a direction being transverse from the scraper axis A. The through-holes 260 interconnects the engagement surface portion 215a with the engagement surface portion 215c. In the example embodiment, there are four such through-holes 260. Through-holes may alternatively extend through one or more of the reinforcement portions. This is illustrated in FIG. 4C for the example embodiment, where the through-holes 261 extend through reinforcement portion 251d. Through-holes may however be provided also in the other reinforcement portions 151a-c. The through-holes 260, 261 may be advantageous because they allow the second material which constitutes the scraper element 220 to extend therethrough thus further strengthening the structural integrity of the scraper blade 200. Although illustrated herein for the second example embodiment only, through-holes 260, 261 may also be used for the first example embodiment, or any other embodiment falling within the scope of the appended claims.

The material properties of the conveyor belt scraper blade of the disclosure will now be described in detail. This will be done with reference to the first example embodiment, conveyor belt scraper blade 100, but the description is equally valid for other example embodiments described herein, and for other example embodiments falling within the scope of the claims. When designing the conveyor belt scraper blade 100 one important factor is the material. The supporting structure 110 is made of a first material and the scraper element 120 is made of a second material. The first and the second materials are different. The use of two different materials allows selecting the material characteristics independently from each other. This may allow providing a supporting structure 110 having one preferred characteristic to contribute with one function of the conveyor belt scraper blade 100, and the scraper element 120 having other characteristics to contribute with another function.

A purpose of the supporting structure 110 is to provide structural integrity to the conveyor belt scraper blade 100. An advantage of the supporting structure 110 is that it allows minimizing the amount of material for holding the structural shape of the conveyor belt scraper blade 100. This may allow minimizing both the amount of material used for the supporting structure 110 and the amount of material used for the scraper element 120. The first material, from which the supporting structure 110 is made, may be biodegradable and/or biobased. Providing a first material which is biodegradable and/or biobased allows to further reduce the impact on the environment. When the remaining part of a worn-out scraper 100 is replaced, it may be disposed of in a sustainable way. It may for example be shredded into smaller elements and composted. Thus, the provision of these materials may completely remove, or at least reduce, the increase of landfill. The first material may comprise one or more from the list of: thermoplastic elastomer, polyvinyl chloride, acrylonitrile styrene acrylate and polyethylene. The first material may be a thermoplastic polymer. One suitable thermoplastic polymer may be acrylonitrile styrene acrylate (ASA), also called acrylic styrene acrylonitrile, which is an amorphous thermoplastic developed as an alternative to acrylonitrile butadiene styrene (ABS). It is an acrylate rubber-modified styrene acrylonitrile copolymer. It has high UV resistance and mechanical properties making it a suitable material for use in an extrusion process.

The first material may comprise a biodegradable material, such as a biodegradable thermoplastic elastomer. The first material may be a composition of two or more compounds. The two or more compounds may be selected from the list of thermoplastic elastomers, polyvinyl chloride, acrylonitrile styrene acrylate (ASA), and polyethylene, but may alternatively be selected from other compounds.

The purpose of the scraping element 120 is to perform a scraping action against the conveyor belt surface 26. Important characteristics for the scraping element 120 may be to be wear-resistant, and flexible for decreasing the risk of the scraper element 120 damaging the conveyor belt surface 24. The second material, of which the scraper element 120 is made, may comprise a polymer such as polyurethane or a thermoplastic elastomer. The second material may alternatively comprise a carbide material, for example in the form of a carbide powder mixed in a further material such as a polymeric material. Polyurethane may provide low friction, high wear resistance, and high strength. Another advantage is that a polyurethane-based scraper element may be formed by moulding. The second material may be a polyurethane composite material. Thermoplastic elastomers (TPE) show advantages typical of both rubbery materials and plastic materials. The benefit of using thermoplastic elastomers may be the ability to stretch to moderate elongations and return to its near original shape creating a longer life and better physical range than many other materials. Another advantage of thermoplastic elastomers is that, while most elastomers are thermosets, thermoplastic elastomers are in contrast relatively easy to use in manufacturing, for example, by injection moulding and extrusion processes. The thermoplastic elastomer may be thermoplastic polyurethane (TPU). Carbide may be suitable for some embodiments of the conveyor belt scraper blade since it is highly wear resistant. The second material could also comprise other kind of materials suitable for scraping the conveyor belt, for example rubber.

The first material may have a higher hardness than the second material. The hardness of the material may be measured with a Shore durometer. The second material may have a hardness of 50-95° Shore A and in general more preferably 70° Shore A. When the first material is a harder material than the second material the supporting structure can provide the stability needed for the conveyor belt scraper blade to keep its shape during use.

The supporting structure of the conveyor belt scraper blades of the disclosure may be manufactured, at least in part, by an extrusion process. The extrusion process is well known in the art and therefore not described in detail herein. The extrusion process is a reliable process for providing a product having a constant cross-sectional profile. Such a product may be the supporting structure and/or the scraper element(s) of the disclosure. With the extrusion process, it may be easy to manufacture the supporting structure which makes it beneficial from an economical point of view.

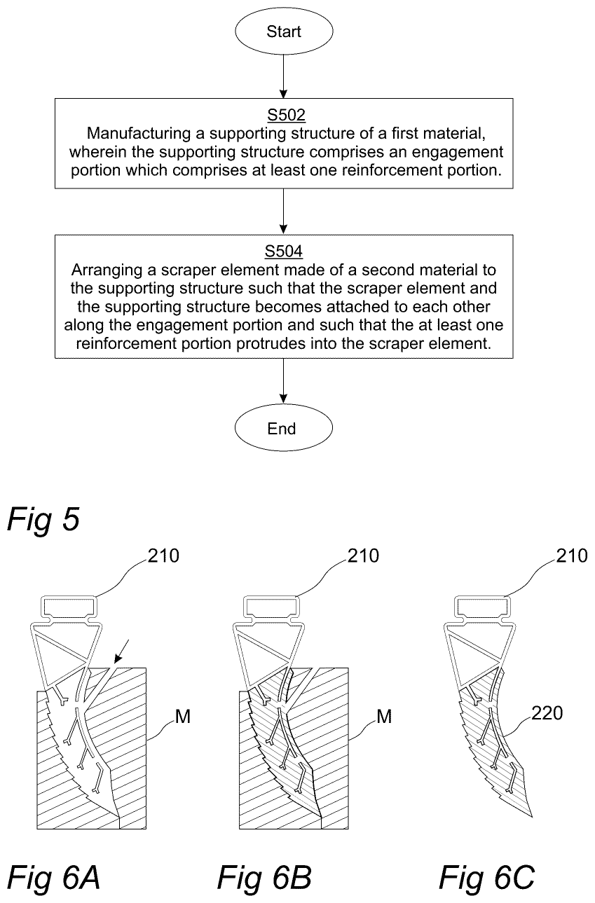

A method of manufacturing a conveyor belt scraper blade will now be described with reference to FIG. 5. The method is equally applicable to both example embodiment of the disclosure and any other embodiment falling within the scope of the appended claims. The scraper blade 100, 200 presents a scraper tip 112 at a first end 111 and a mounting base 114 at a second 113, opposite, end and is tapered towards the scraper tip 112 at least at the first end 111. The method comprises the steps of:
a) manufacturing S502 a supporting structure 110, 210 made of a first material, wherein the supporting structure 110, 210 comprises a base portion 170 and an engagement portion 150, 250, wherein the base portion 170 includes the mounting base 114, and wherein the engagement portion 150, 250 interconnects with the base portion 170 and extends from the base portion 170 towards the first end 111, wherein the engagement portion 150, 250 comprises at least one reinforcement portion 151a-d; 251d, and
b) arranging S504 a scraper element 120, 220 made of a second material to the supporting structure 110, 210 such that the scraper element 120, 220 and the supporting structure 110, 210 becomes attached to each other along the engagement portion 150, 250 and such that the at least one reinforcement portion 151a-d; 251d protrudes into the scraper element 120, 220 thereby reinforcing an attachment between the scraper element 120, 220 and the supporting structure 110, 210.

The step of manufacturing S502 the supporting structure 110, 210 may be achieved, at least in part, by an extrusion process, an injection moulding process, or a 3D printing process.

The step of arranging S504 the scraper element 120, 220 to the supporting structure 110, 210 may comprise arranging the supporting structure 110, 210 into a mould M, as illustrated in FIG. 6A for the second example embodiment. The second material may then be supplied in liquid form into the mould M such that the second material meets the supporting structure 210 along the engagement portion 250. Supply of the material is indicated by the arrow in FIG. 6A. FIG. 6B illustrates a completely filled mould M. Once filled, the second material will bind with the first material of the supporting structure 210 to form a coherent structure during cooling. The mould M may then be removed. As readily appreciated by the person skilled in the art, the process will be similar for the first example embodiment, the mould having to be somewhat smaller, and the liquid second material filled from the opposite end of the mould.

As previously stated, the first and second materials are different. This does however not rule out that both the first and the second material may comprise the same compound, such as e.g. polyethylene. The first and second materials may each be a respective composition of two or more compounds where one of these two or more compounds is common for both materials.

The figures of this disclosure illustrate the conveyor belt scraper blade 100, 200 before being used. The conveyor belt scraper blade 100, 200 is however structured and arranged to wear off during use and the scraper element 120, 220 is arranged with respect to the supporting structure 110, 210 such that the scraper element 120, 220, at the end of a service life of the conveyor belt scraper blade 100, 200, is fully or partially worn off. During use, the conveyor belt scraper blade 100, 200 will be subject to wear at the contact point between the conveyor belt scraper blade 100, 200 and the conveyor belt surface 24. The wear will occur at the position of the conveyor belt scraper blade 100, 200 which contacts the conveyor belt surface 24, i.e. at the scraping region 16. A freshly replaced conveyor belt scraper blade 100, 200 will therefore first be subject to wear of the scraper element 120, 220. As the top portion of the scraper element 120, 220 has worn off and the conveyor belt surface 24 reaches the top of the supporting structure 110, 210, also the supporting structure 110, 210 will gradually wear down. Thus, the scraper element 120, 220 can be subject to wear both alone and together with the supporting structure 110, 210. At the end of the service life of the conveyor belt scraper blade 100, 200, the scraper element 120, 220 is fully, or partially, worn off. Thus, when replacing the conveyor belt scraper blade 100, 200, the waste material will predominately, or only, comprise the remaining parts of the supporting structure 110, 210. Therefore, the appearance of a used conveyor belt scraper blade 100, 200 can be very different from the appearance of a new conveyor belt scraper blade 100, 200 as illustrated in the figures.

The person skilled in the art realizes that the present disclosure by no means is limited to the preferred embodiments described above. On the contrary, many modifications and variations are possible within the scope of the appended claims. Additionally, variations to the disclosed embodiments can be understood and effected by the skilled person in practicing the claimed invention, from a study of the drawings, the disclosure, and the appended claims.

1. A conveyor belt scraper blade having an extension along a scraper axis and configured to scrape off material from a conveyor belt surface along a scraping region extending in parallel with said scraper axis said conveyor belt scraper blade presenting a scraper tip at a first end and a mounting base at a second, opposite, end and being tapered towards the scraper tip at least at the first end said conveyor belt scraper blade comprising:
a supporting structure which comprises a base portion and an engagement portion, wherein said base portion includes said mounting base, and wherein said engagement portion interconnects with the base portion and extends from the base portion towards the first end, wherein said engagement portion comprises at least one reinforcement portion, and
a scraper element,
wherein the scraper element and the supporting structure are attached to each other along said engagement portion such that the at least one reinforcement portion protrudes into the scraper element thereby reinforcing an attachment between the scraper element and the supporting structure,
wherein the conveyor belt scraper blade is structured and arranged to wear off during use and the scraper element is arranged with respect to the supporting structure such that the scraper element, at the end of a service life of the conveyor belt scraper blade, is fully or partially worn off,
wherein the supporting structure is made of a first material and the scraper element is made of a second material, and wherein the first and second materials are different.

2. The conveyor belt scraper blade according to claim 1, wherein the engagement portion protrudes into the scraper element such that the scraper element partially encloses the engagement portion from the base portion (170) towards the first end in directions being transverse to the scraper axis.

3. The conveyor belt scraper blade according to claim 1, wherein the supporting structure has a constant cross-sectional profile along the scraper axis.

4. The conveyor belt scraper blade according to claim 3, wherein the supporting structure is manufactured, at least in part, by an extrusion process, an injection moulding process, or a 3D printing process.

5. The conveyor belt scraper blade according to claim 1, wherein the second material comprises polyurethane or a thermoplastic elastomer.

6. The conveyor belt scraper blade according to claim 1, wherein the first material is biodegradable and/or biobased.

7. The conveyor belt scraper blade according to claim 1, wherein the first material has a higher hardness than the second material.

8. The conveyor belt scraper blade according to claim 1, wherein the first material comprises one or more from the list of: a thermoplastic elastomer, polyvinyl chloride, acrylonitrile styrene acrylate, and polyethylene.

9. The conveyor belt scraper blade according to claim 1, wherein each of the one or more reinforcement portions has a proximal end which connects to the engagement portion, and a distal end arranged opposite to the proximal end, wherein the distal end comprises an anchoring portion which has a thickness being larger than a thickness of the reinforcement portion, said thicknesses being defined in a plane being transverse to the scraper axis.

10. The conveyor belt scraper blade according to claim 9, wherein the anchoring portion comprises two sub portions which protrude out from the distal end in different directions.

11. The conveyor belt scraper blade according to claim 1, wherein the supporting structure comprises one or more hollow portions each defining a respective interior volume.

12. The conveyor belt scraper blade according to claim 11, wherein one of the one or more hollow portions are located within the base portion.

13. The conveyor belt scraper blade according to claim 1, wherein the supporting structure comprises one or more through-holes which extend through said engagement portion.

14. A conveyor belt scraper assembly for scraping off material from a conveyor belt surface, comprising:
a plurality of conveyor belt scraper blades according to claim 1, and
a support shaft structured and arranged to support said plurality of conveyor belt scraper blades, and
tensioning means configured to exert a torque or a force onto the support shaft for pressing the plurality of conveyor belt scraper blades towards the conveyor belt surface.

15. A method of manufacturing a conveyor belt scraper blade which presents a scraper tip at a first end and a mounting base at a second, opposite, end and which is tapered towards the scraper tip at least at the first end, the method comprising the steps of:
a) manufacturing a supporting structure made of a first material, wherein the supporting structure comprises a base portion and an engagement portion, wherein said base portion includes said mounting base, and wherein said engagement portion interconnects with the base portion and extends from the base portion towards the first end, wherein said engagement portion comprises at least one reinforcement portion, and
b) arranging a scraper element made of a second material to the supporting structure such that the scraper element and the supporting structure becomes attached to each other along said engagement portion and such that the at least one reinforcement portion protrudes into the scraper element thereby reinforcing an attachment between the scraper element and the supporting structure.

16. The method according to claim 15, wherein the step of manufacturing the supporting structure is achieved, at least in part, by an extrusion process, an injection moulding process, or a 3D printing process.

17. The method according to claim 15, wherein the step of arranging the scraper element to the supporting structure comprises:
arranging the supporting structure into a mould,
supplying the second material in liquid form into the mould such that the second material meets the supporting structure along the engagement portion,
whereby the second material binds with the first material of the supporting structure to form a coherent structure during cooling.

18. The method according to claim 15, wherein the first and second materials are different.
